(19) United States
(12) Patent Application Publication
(10) Pub. No.: US 2022/0138656 A1
(43) Pub. Date: May 5, 2022

(54) DECISION-MAKING AGENT HAVING HIERARCHICAL STRUCTURE

(71) Applicant: AGILESODA INC., Seoul (KR)

(72) Inventors: Pham-Tuyen LE, Suwon-si (KR); Cheol-Kyun RHO, Seoul (KR); Seong-Ryeong LEE, Seoul (KR); Ye-Rin MIN, Namyangju-si (KR)

(73) Assignee: AGILESODA INC., Seoul (KR)

(21) Appl. No.: 17/509,322

(22) Filed: Oct. 25, 2021

(30) Foreign Application Priority Data
Oct. 30, 2020 (KR) 10-2020-0143282

(51) Int. Cl. G06Q 10/06; G06N 5/04

(52) U.S. Cl. CPC G06Q 10/06375; G06N 5/045; G06N 5/043

(57) ABSTRACT

Disclosed is a decision-making agent having a hierarchical structure. The present invention allows a user without knowledge about reinforcement learning to learn by easily setting and applying core factors of the reinforcement learning to business problems.

### CROSS-REFERENCE TO RELATED APPLICATIONS

This application claims the benefit under 35 USC § 119(a) of Korean Patent Application No. 10-2020-0143282 filed on Oct. 30, 2020, in the Korean Intellectual Property Office, the entire disclosures of which are incorporated herein by reference for all purposes.

### BACKGROUND OF THE INVENTION

### Field of the Invention

The present invention relates to a decision-making agent having a hierarchical structure, and more specifically, to a decision-making agent having a hierarchical structure, which allows a user without knowledge about reinforcement learning to learn by easily setting and applying core factors of the reinforcement learning to business problems.

### Background of the Related Art

In order to allow an enterprise to organize and use business resources, components of business and information technologies should be evaluated, identified, organized, altered, expanded and integrated.

However, most enterprises lack a basis for deriving measures for planning strategic information technologies, and developing the measures to deploy essential components of the business and information technologies.

Therefore, a business may not guarantee availability of successful information techniques for cross-functional business processes toward end-to-end activities.

It is required to provide a basic framework or structure that allows business architectures to derive technical architectures, and allows the technical architectures to directly influence the configuration of the business architectures by enabling or providing new and creative methods of doing business.

When a general business architecture structure is used, a layered architecture pattern is mainly used.

Components of this layered architectural pattern are configured as horizontal layers, and each layer is configured to perform a specific function.

Although the number or types of layers that should exist in a pattern is not specified, the layered structure pattern is generally configured of four standard layers.

FIG. 1 is a block diagram showing the platform of a general layered architecture pattern.

Referring to FIG. 1, a platform 10 of a layered architecture pattern is configured of a presentation layer 11, a business layer 12, a persistence layer 13, and a database layer 14, and forms abstraction of a work that should be performed to satisfy business requests.

For example, when a request is input, the presentation layer 11 does not need to know the request or displays only corresponding information on a screen in a specific format to obtain a method about worries or customer data. The business layer 12 does not need to worry about a method of specifying a customer data format to display customer data on the screen, or about the source of the customer data. The business layer 12 is configured to take data from the persistence layer 13, calculate a value for the data, perform data aggregation or the like, and deliver information on the result thereof to the presentation layer 11.

In addition, when a request is input and moves from a layer to a next layer, the request moves to a layer next to a layer immediately next to the corresponding layer by way of the immediately next layer. For example, a request initiated from the presentation layer 11 should pass through the business layer 12 and move to the persistence layer 13 before finally arriving at the database layer 14.

However, although the architecture of a hierarchical structure according to the prior art may isolate changes through an isolation layer such as the persistence layer, there is a problem in that it is difficult to change an architecture pattern and a lot of time is required, due to close combination of components generally found together with monolithic characteristics in most implementations.

In addition, the architecture of a hierarchical structure according to the prior art has a problem of additionally distributing applications since the entire application (or a considerable part of the application) should be redistributed once a component is changed.

In addition, as the architecture pattern of a hierarchical structure according to the prior art is implemented in a monolithic type, an application that is built using such an architecture pattern may be expanded to a layered architecture by splitting a layer into separate physical distributions or by cloning the entire application to several nodes. However, there is a problem in that the application is difficult to expand since it is generally too large to subdivide.

In addition, the architecture of a hierarchical structure according to the prior art has a problem in that use of the architecture is limited since only users with specialized knowledge related to reinforcement learning or AI are allowed to use to solve business problems.

### PATENT DOCUMENT

(Patent Document 1) Korean Laid-Opened Patent Publication No. 10-2002-0026587 (Title of the Invention: Structure and method of modeling integrated business and information technology frameworks and architecture in support of a business)

### SUMMARY OF THE INVENTION

Therefore, the present invention has been made in view of the above problems, and it is an object of the present invention to provide a decision-making agent having a hierarchical structure, which allows a user without knowledge about reinforcement learning to learn by easily setting and applying core factors of the reinforcement learning to business problems.

To accomplish the above object, according to one aspect of the present invention, there is provided a decision-making agent having a hierarchical structure, the agent comprising: a first layer unit for defining environmental factors of reinforcement learning suitable for a business domain; a second layer unit for setting an auto-tuning algorithm for increasing learning speed and enhancing performance of the reinforcement learning; a third layer unit for selecting a generation model and an explainable artificial intelligence model algorithm for learning performance or explanation of the reinforcement learning; and a fourth layer unit for selecting a reinforcement learning algorithm for performing training of the agent according to a business domain.

In addition, the first layer unit according to the embodiment defines a state, an action, a reward, an agent, and state-transition as environment factors.

In addition, the first layer unit according to the embodiment includes: a state encoder for extracting a D-dimensional vector from data and designing a feature space; and a state decoder for transforming the data from the feature space into a D-dimensional space.

In addition, the first layer unit according to the embodiment includes: an action encoder for transforming into a K-dimensional vector in a D-dimensional vector space; and an action decoder for transforming the K-dimensional vector into a form of an action, wherein the form of the action is any one among a discrete decision, a continuous decision, and a combination of the discrete decision and the continuous decision.

In addition, the first layer unit according to the embodiment selects any one among a customized reward defined and used by a user, a wizard reward using a variable existing in the data or a key performance indicator (KPI) of each company in a weight adjustment method, and an automatic reward used by the user for the purpose of confirming a baseline of simple learning and reinforcement learning as a variable for designing a reward function.

In addition, the second layer unit according to the embodiment includes: an auto-featuring unit for automatically performing preprocessing on structured data, image data, and text data by analyzing a type of a state; an auto-design unit for automatically designing a neural network architecture suitable for the business domain; an auto-tuning unit for automatically performing tuning of hyperparameters required for improvement of performance in the reinforcement learning; and an auto-rewarding unit for selecting a reward type such as automatic weight search or automatic reward from a reward required for the reinforcement learning, and automatically calculating the reward.

In addition, the third layer unit according to the embodiment includes: an explainable AI model unit for providing a model for interpreting decision-making of an agent; a generative AI model unit for generating data to make up for insufficient data when the agent makes a decision; and a trained model unit for providing a previously trained model.

In addition, the fourth layer unit according to the embodiment includes: a model-free reinforcement learning unit in which a model learns while exploring an environment without a specific assumption about the environment; a model-based reinforcement learning unit in which a model learns on the basis of information on the environment; a hierarchical RL algorithm unit for providing an algorithm of dividing and arranging the agent to several layers so that the agent of each layer may learn using its own reinforcement learning algorithm; and a multi-agent algorithm unit for providing, when a plurality of agents exists in one environment, an algorithm for the agents to learn through competition or collaboration among the agents.

### BRIEF DESCRIPTION OF THE DRAWINGS

FIG. 1 is a block diagram showing the platform of a general layered architecture pattern.

FIG. 2 is a block diagram showing a decision-making agent having a hierarchical structure according to an embodiment of the present invention.

FIG. 3 is a block diagram showing the configuration of a first layer unit of a decision-making agent having a hierarchical structure according to the embodiment of FIG. 2.

FIG. 4 is a block diagram showing the state configuration of a first layer unit according to the embodiment of FIG. 3.

FIG. 5 is a block diagram showing the action configuration of a first layer unit according to the embodiment of FIG. 3.

FIG. 6 is a block diagram showing the configuration of a second layer unit of a decision-making agent having a hierarchical structure according to the embodiment of FIG. 2.

FIG. 7 is a block diagram showing the configuration of a third layer unit of a decision-making agent having a hierarchical structure according to the embodiment of FIG. 2.

FIG. 8 is a block diagram showing the configuration of a fourth layer unit of a decision-making agent having a hierarchical structure according to the embodiment of FIG. 2.

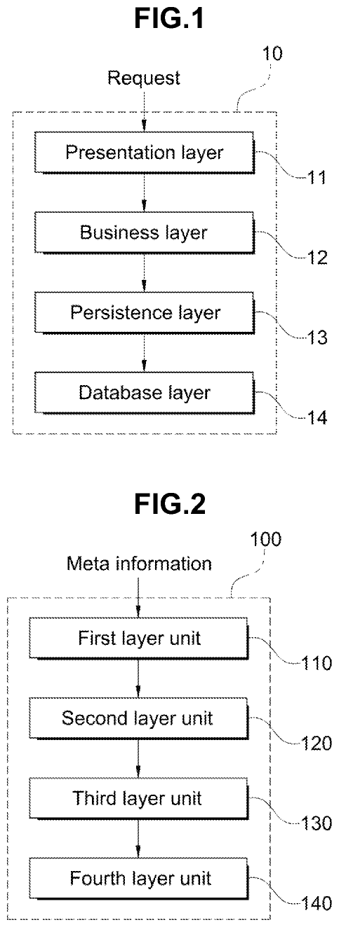

### DESCRIPTION OF SYMBOLS

| | | | |
|---|---|---|---|
| 100: | Agent | 110: | First layer unit |
| 111: | State unit | 111a: | State encoder |
| 111b: | State decoder | 112: | Action unit |
| 112a: | Action encoder | 112b: | Action decoder |
| 113: | Reward unit | 114: | Agent unit |
| 115: | Transition unit | 120: | Second layer unit |
| 121: | Auto-featuring unit | 122: | Auto-design unit |
| 123: | Auto-tuning unit | 124: | Auto-rewarding unit |
| 130: | Third layer unit | 131: | Explainable AI model |
| | | | unit |
| 132: | Generative AI model | 133: | Trained model unit |
| 140: | Fourth layer unit | | |
| 141: | Model-free reinforcement | | |
| | learning unit | | |
| 142: | Model-based reinforcement | | |
| | learning unit | | |
| 143: | Hierarchical RL algorithm unit | | |
| 144: | Multi-agent algorithm unit | | |
| 145: | Other algorithm units | | |

### DETAILED DESCRIPTION OF THE PREFERRED EMBODIMENT

Hereinafter, the present invention will be described in detail with reference to preferred embodiments of the present invention and the accompanying drawings, and it will be described on the premise that like reference numerals in the drawings refer to like components.

Prior to describing the details for embodying the present invention, it should be noted that components not directly related to the technical gist of the present invention are omitted within the scope of not disturbing the technical gist of the present invention.

In addition, the terms or words used in the specification and claims should be interpreted as a meaning and concept meeting the technical spirit of the present invention on the basis of the principle that the inventor may define the concept of appropriate terms to best describe his or her invention.

In this specification, the expression that a part “includes” a certain component means that it does not exclude other components, but may further include other components.

In addition, the terms such as “ . . . unit”, “ . . . group”, and “ . . . module” mean a unit that processes at least one function or operation, which may be divided into hardware, software, or a combination of the two.

In addition, the term “at least one” is defined as a term including singular and plural, and although the term “at least one” does not exist, it is apparent that each component may exist in a singular or plural form, and may mean singular or plural.

In addition, that each component is provided in singular or plural may be changed according to embodiments.

Hereinafter, a preferred embodiment of a decision-making agent having a hierarchical structure according to an embodiment of the present invention will be described in detail with reference to the accompanying drawings.

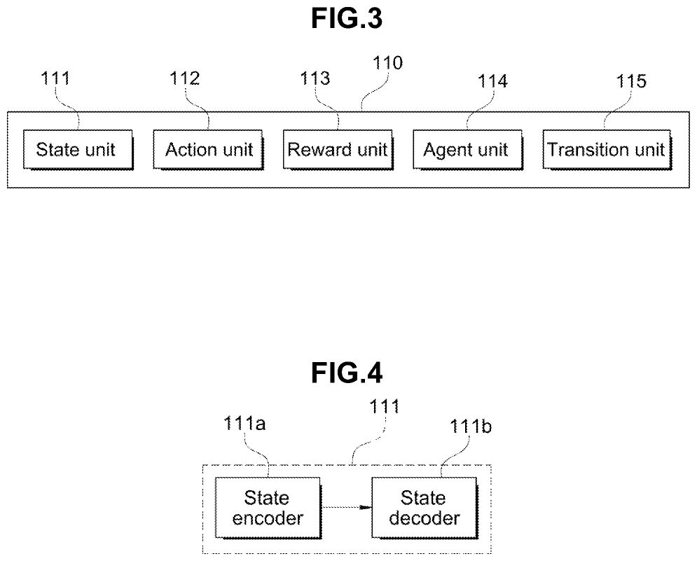

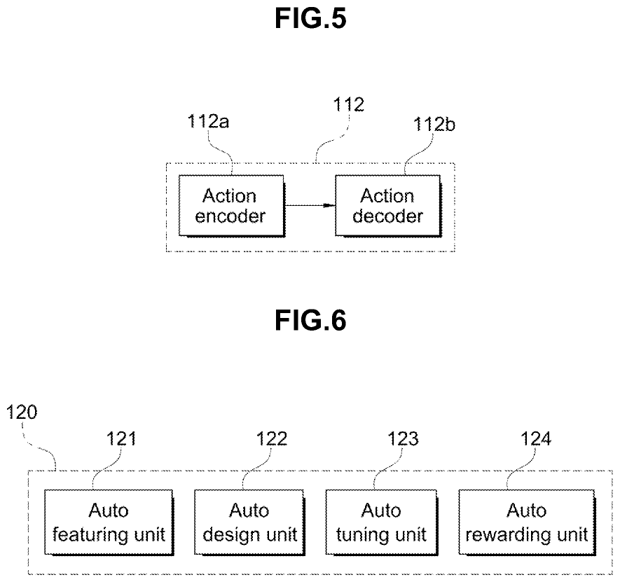

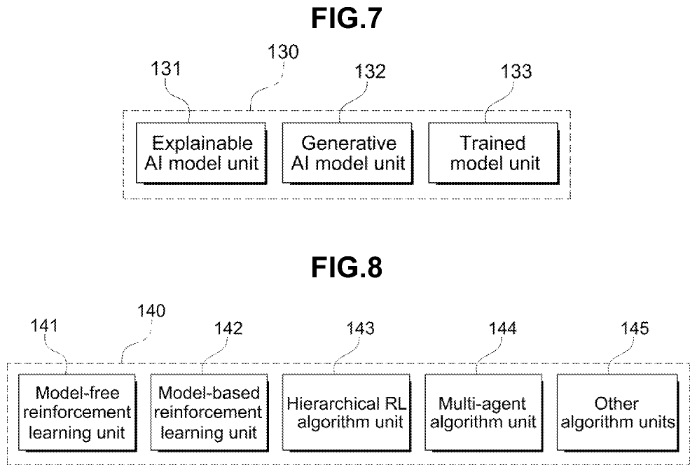

FIG. 2 is a block diagram showing a decision-making agent having a hierarchical structure according to an embodiment of the present invention, FIG. 3 is a block diagram showing the configuration of a first layer unit of a decision-making agent having a hierarchical structure according to the embodiment of FIG. 2, FIG. 4 is a block diagram showing the state configuration of a first layer unit according to the embodiment of FIG. 3, FIG. 5 is a block diagram showing the action configuration of a first layer unit according to the embodiment of FIG. 3, FIG. 6 is a block diagram showing the configuration of a second layer unit of a decision-making agent having a hierarchical structure according to the embodiment of FIG. 2, FIG. 7 is a block diagram showing the configuration of a third layer unit of a decision-making agent having a hierarchical structure according to the embodiment of FIG. 2, and FIG. 8 is a block diagram showing the configuration of a fourth layer unit of a decision-making agent having a hierarchical structure according to the embodiment of FIG. 2.

Referring to FIGS. 2 to 8, a decision-making agent 100 having a hierarchical structure according to an embodiment of the present invention may be configured as a platform, may be installed and operate in a computer system or a server system, and is configured to include a first layer unit 110, a second layer unit 120, a third layer unit 130, and a fourth layer unit 140.

The first layer unit 110 is a configuration for defining environmental factors of reinforcement learning suitable for a business domain, and may be configured of a representation layer, and it allows a user to define a state, an action, a reward, an agent, and state-transition as the environment factors on an arbitrary user interface (UI).

In addition, the first layer unit 110 may be configured to include a state unit 111 for defining a state to be suitable for input data, an action unit 112 for defining an action, a reward unit 113 for defining a reward, an agent unit 114 for selecting a reinforcement learning agent suitable for a business domain, and a transition unit 115 for measuring uncertainty of business problems.

Here, the business domain may be an input to which the agent should respond and a knowledge provided to the agent. For example, in the case of automobile manufacturing process automation, it may mean business information that is essential to know in modeling processes, materials, and the like of the manufacturing process.

The state unit 111 defines a part used as a state in an input dataset as a state, and the state defined herein may be used while the agent learns.

In addition, since the processing method varies according to data of various formats, such as structured data, image data, text data, and the like, as well as algorithms, the state unit 111 may be configured to include a state encoder 111a for defining a state, and a state decoder 111b.

The state encoder 111a extracts a D-dimensional vector from the input dataset and designs a feature space from the extracted D-dimensional vector.

The state decoder 111b defines a state by transforming representation data from the feature space designed by the state encoder 111a into a D-dimensional space X∈R^{D}.

The action unit 112 is a configuration for defining an action, and since decision-making in an actual business is configured to be very complicated, it transforms the decision-making into a form that can be optimized through a reinforcement learning algorithm, and may be configured to include an action encoder 112a and an action decoder 112b.

The action encoder 112a transforms into a K-dimensional vector Y∈R^{K} in a D-dimensional vector space X∈R^{D} through the reinforcement learning algorithm.

The action decoder 112b transforms the K-dimensional vector into the form of an action, and the action transformed herein may be transformed in any one of forms including a discrete decision such as Yes, No, Up, Down, Stay, and the like, a continuous decision such as a float value or the like, and a combination of the discrete decision and the continuous decision.

The reward unit 113 is a configuration for defining factors for defining a reward system for learning, e.g., factors needed to calculate a reward, such as a correct answer (label), a goal (metric), or the like, and may be expressed as a correct answer (label) in a dataset having a correct answer, or may be expressed as a goal (metric) of an enterprise such as revenue, cost or the like.

In addition, the reward may be obtained through an action of the agent in a state, and the goal is to have the agent take an action that maximizes the total reward.

In addition, the reward unit 113 may set an automatic reward for the variables for designing a reward function in a customized method, a wizard method, or a method utilizing a correct answer.

The customized method allows a reward defined by the user through the user interface to be set as a variable for designing a reward function.

The wizard method outputs a reward that uses a variable existing in a data or a key performance indicator (KPI) of each company in a weight adjustment method so that the reward may be set as a variable for designing a reward function.

The automatic reward is set as a variable for designing a reward function so that a user may use it for the purpose of confirming the baseline of simple learning and reinforcement learning.

In addition, the automatic reward may use a method of utilizing a correct answer, or may set a built-in reward function (A2GAN) that calculates a reward from a given state-action pair using a correct answer (label).

The agent unit 114 is a configuration for selecting an agent based on business domain characteristics and a reinforcement learning algorithm. For example, a policy-based agent may be compatible with a policy-based reinforcement learning algorithm, and a value-based agent may be compatible with only a value-based reinforcement learning algorithm, and an action-based agent is compatible with a domain defined by discrete actions.

The transition unit 115 is a configuration for expressing, when an agent takes an arbitrary action, a state that comes next or an effect of the action performed by the agent, and may express the state using Hidden Markov Models (HMMs), Gaussian Processes (GPs), Gaussian Mixture Models (GMMs), or the like.

In addition, the transition unit 115 configures a state transition function in another business area in a customized form, and allows the state transition model to be set using labeled data in a business area.

The second layer unit 120 is a configuration for setting an auto-tuning algorithm for increasing learning speed and enhancing performance of reinforcement learning, may be configured as a catalyst layer so that an agent may set quick understanding of simulated models, a good state configuration, an optimal architecture configuration, and an automatic reward function system using a user interface, and may be configured of an auto-featuring unit 121, an auto-design unit 122, an auto-tuning unit 123, and an auto-rewarding unit 124.

The auto-featuring unit 121 is a configuration for analyzing the type of the state unit 111 to perform preprocessing on the structured data, image data, and text data, and selects an important state by analyzing a state for a given simulated model.

In addition, the auto-featuring unit 121 allows to automatically avoid overfitting of dimension for a given state through an algorithm.

In addition, the auto-featuring unit 121 may automatically configure a state, or may select an arbitrary state and configure the state as a data pipeline so that a user may perform configuration of the state.

In addition, the auto-featuring unit 121 makes it possible to perform various preprocessing processes, such as replacement of missing values, continuous variables, categorical variables, dimensionality reduction, variable selection, outlier removal and the like, using a preprocessing module such as Scikit-Learn, Scipy or the like that provides various algorithms for classification and regression, clustering, dimensionality reduction, model selection, and preprocessing performed on structured data.

In addition, the auto-featuring unit 121 makes it possible to perform preprocessing such as image denoising, data augmentation, resizing and the like on image data.

In addition, the auto-featuring unit 121 makes it possible to perform preprocessing on text data through a module for tokenizing, filtering, cleansing or the like.

The auto-design unit 122 is a configuration for automatically designing a neural network (multi-layer perceptron, convolutional neural network) architecture suitable for a business domain, and should search for an optimal neural network architecture through reinforcement learning, evolutionary, Bayesian optimization, gradient-based optimization, or the like.

That is, the auto-design unit 122 automatically searches for an optimal architecture since an optimal architecture suitable for a corresponding business domain is required to train an agent of good performance.

The auto-tuning unit 123 is a configuration operating to automatically perform tuning of hyperparameters, which requires many attempts in order to obtain high performance in reinforcement learning, and searches for hyperparameters that greatly affect the performance of a reinforcement learning agent using grid-search, Bayesian optimization, gradient-based optimization, or population-based optimization, and provides an optimal combination of hyperparameter based on the result of the search.

The auto-rewarding unit 124 is a configuration operating to automatically set a reward required for reinforcement learning according to a preset reward pattern, and selects a reward type such as automatic weight search, automatic reward or the like so that the reward may be automatically calculated.

The third layer unit 130 is a configuration for selecting a generation model and an explainable artificial intelligence model algorithm for learning performance or explanatory power of reinforcement learning, using optimization information, which is a catalyst such as various preprocessing processes, optimal neural network architecture, hyperparameters and the like processed in the second layer unit 120, and may be configured to include an explainable AI model unit 131, a generative AI model unit 132, and a trained model unit 133.

In addition, the third layer unit 130 may classify the type of a model on the basis of input data type, for example, structured data, image data, text data, or the like.

The explainable AI model unit 131 is a configuration for providing a model for interpreting decision-making of an agent, and provides a model for a domain that needs explanation for the decision-making since a neural network algorithm including reinforcement learning lacks explanatory power for learning results.

The generative AI model unit 132 is a configuration for providing a model for generating data to make up for insufficient data when an agent makes a decision, and provides a model for generating a data having a replaced missing value in place of a data having a missing value using existing data distribution.

In addition, data may be augmented to solve the problem of data shortage, and may be provided as a model having a correct answer by labeling a data without a correct answer.

The trained model unit 133 is a configuration for providing a previously trained model, and provides a model capable of quickly training an agent using a previously trained model.

The fourth layer unit 140 is a configuration for selecting a reinforcement learning algorithm for training an agent according to a business domain, and may be configured to include a model-free reinforcement learning unit 141, a model-based reinforcement learning unit 142, a hierarchical reinforcement learning algorithm unit 143, and a multi-agent algorithm unit 144.

The model-free reinforcement learning unit 141 is a configuration for providing an algorithm that performs an action, and performs an action through a value-based algorithm and a policy-based algorithm.

Here, the value-based algorithm may be configured of Deep Q Networks (DQNs), Double Deep Q Networks (DDQNs), Dueling Double Deep Q Networks (DDQNs), or the like.

In addition, the policy-based algorithm may be divided into a direct policy search algorithm (DPS) and an actor critic algorithm (AC) according to whether or not a value function is used.

The policy-based algorithm may be configured of AC-based algorithms, such as Advantage Actor Critic (A2C), Trust Region Policy Optimization (TRPO), Proximal Policy Optimization (PPO), Deep Deterministic Policy Gradient (DDPG), Soft Actor Critic (SAC), and the like.

Unlike the model-free reinforcement learning unit 141, the model-based reinforcement learning unit 142 is a configuration for providing an algorithm that a model learns in a state having information on the environment, and trains the agent using a transition model of a model-based algorithm.

In addition, the model-based algorithm uses both real data and data from a simulation environment for update of policy, and may train a transition model using real data or use a mathematical model such as a Linear Quadratic Regulator (LQR).

In addition, the model-based reinforcement learning unit 142 may be configured of DynA, Probabilistic Inference for Learning Control (PILCO), Monte-Carlo Tree Search (MCTS), World Models, or the like.

When a business domain is too complicated to solve the problem with a single agent, the hierarchical RL algorithm unit 143 provides an algorithm of a structure that can divide and arrange an agent to several layers so that the agent in each layer may learn using its own reinforcement learning algorithm and help learning of a master agent.

When a plurality of agents exists in one environment, the multi-agent algorithm unit 144 provides an algorithm for the agents to learn through competition or cooperation among the agents.

In addition, the fourth layer unit 140 may be configured to include other algorithm units 145 including an algorithm that trains an agent in a way of supervised learning, or inversely finds a reward function using a labeled dataset and uses the reward function for learning of an unlabeled dataset, a meta RL algorithms such as Long Short Term Memory (LSTM), Model-Agnostic Meta Learning (MAML), Meta Q Learning (MQL) or the like, a batch RL algorithm that trains using offline data in a business domain where real-time interaction with the environment is difficult, an algorithm using A2GAN, and the like.

Therefore, as a user without knowledge about reinforcement learning selects and sets core factors of reinforcement learning through a user interface, the user may learn by easily applying the reinforcement learning to business problems.

In addition, reinforcement learning may be easily applied to business problems of a user based only on the knowledge of the user about a domain and about general machine learning, and the user may adopt AI by further focusing on the knowledge about the domain rather than the knowledge related to reinforcement learning or AI in order to solve business problems using the reinforcement learning.

In addition, high-level performance can be achieved by constructing various reinforcement learning designs for business problems with minimal effort compared to a general reinforcement learning platform.

The present invention has an advantage in that a user without knowledge about reinforcement learning may learn by easily setting and applying core factors of the reinforcement learning to business problems.

In addition, the present invention has an advantage in that reinforcement learning may be easily applied to business problems of a user based only on the knowledge of the user about a domain and about general machine learning.

In addition, the present invention has an advantage in that a user may adopt AI by further focusing on the knowledge about a domain rather than the knowledge related to reinforcement learning or AI in order to solve business problems using the reinforcement learning.

In addition, the present invention has an advantage in that high-level performance can be achieved by constructing various reinforcement learning designs for business problems with minimal effort compared to a general reinforcement learning platform.

Although it has been described above with reference to preferred embodiments of the present invention, those skilled in the art may understand that the present invention may be variously modified and changed without departing from the spirit and scope of the present invention described in the claims below.

In addition, the reference numbers described in the claims of the present invention are only for clarity and convenience of explanation, and are not limited thereto, and in the process of describing the embodiments, thickness of lines or sizes of components shown in the drawings may be shown to be exaggerated for clarity and convenience of explanation.

In addition, since the terms mentioned above are terms defined in consideration of the functions in the present invention and may vary according to the intention of users or operators or the custom, interpretation of these terms should be made on the basis of the content throughout this specification.

In addition, although it is not explicitly shown or described, it is apparent that those skilled in the art may make modifications of various forms including the technical spirit according to the present invention from the description of the present invention, and this still falls within the scope of the present invention.

In addition, the embodiments described above with reference to the accompanying drawings have been described for the purpose of explaining the present invention, and the scope of the present invention is not limited to these embodiments.

What is claimed is:

1. A decision-making agent having a hierarchical structure, the agent comprising:
a first layer unit 110 for defining environmental factors of reinforcement learning suitable for a business domain;
a second layer unit 120 for setting an auto-tuning algorithm for increasing learning speed and enhancing performance of the reinforcement learning;
a third layer unit 130 for selecting a generation model and an explainable artificial intelligence model algorithm for learning performance or explanation of the reinforcement learning; and
a fourth layer unit 140 for selecting a reinforcement learning algorithm for performing training of the agent according to a business domain, wherein
the second layer unit 120 includes:
an auto-featuring unit 121 for selecting an important state by analyzing a type of a state defined in an input dataset by a state unit 111, and automatically performing arbitrary preprocessing on a structured data, an image data, and a text data;
an auto-design unit 122 for automatically designing a neural network architecture by searching for a neural network architecture suitable for the business domain;
an auto-tuning unit 123 for searching for hyperparameters to improve performance of the reinforcement learning, and automatically performing tuning of required hyperparameters by providing an optimal hyperparameter combination based on a search result; and
an auto-rewarding unit 124 for selecting a reward type such as automatic weight search or automatic reward so that a reward required for the reinforcement learning may be automatically set according to a previously set reward pattern, and automatically calculating a reward according to the selected reward type.

2. The agent according to claim 1, wherein the first layer unit 110 defines a state, an action, a reward, an agent, and state-transition as environment factors.

3. The agent according to claim 2, wherein the first layer unit 110 includes:
a state encoder 111a for extracting a D-dimensional vector from data and designing a feature space; and
a state decoder 111b for transforming the data from the feature space into a D-dimensional space.

4. The agent according to claim 3, wherein the first layer unit 110 includes:
an action encoder 112a for transforming into a K-dimensional vector in a D-dimensional vector space; and
an action decoder 112b for transforming the K-dimensional vector into a form of an action, wherein
a form of the action is any one among a discrete decision, a continuous decision, and a combination of the discrete decision and the continuous decision.

5. The agent according to claim 4, wherein the first layer unit 110 selects any one among a customized reward defined and used by a user, a wizard reward using a variable existing in the data or a key performance indicator (KPI) of each company in a weight adjustment method, and an automatic reward used by the user for the purpose of confirming a baseline of simple learning and reinforcement learning as a variable for designing a reward function.

6. The agent according to claim 1, wherein the third layer unit 130 includes:
an explainable AI model unit 131 for providing a model for interpreting decision-making of an agent;
a generative AI model unit 132 for generating data to make up for insufficient data when the agent makes a decision; and
a trained model unit 133 for providing a previously trained model.

7. The agent according to claim 1, wherein the fourth layer unit 140 includes:
a model-free reinforcement learning unit 141 in which a model learns while exploring an environment without a specific assumption about the environment;
a model-based reinforcement learning unit 142 in which a model learns on the basis of information on the environment;
a hierarchical RL algorithm unit 143 for providing an algorithm of dividing and arranging the agent to several layers so that the agent of each layer may learn using its own reinforcement learning algorithm; and
a multi-agent algorithm unit 144 for providing, when a plurality of agents exists in one environment, an algorithm for the agents to learn through competition or collaboration among the agents.
